(19) United States
(12) Patent Application Publication
(10) Pub. No.: US 2026/0222130 A1
(43) Pub. Date: Jul. 30, 2026

(54) Configuring Uplink Positioning Signaling in Radio Resource Control Inactive for Multiple Cells

(71) Applicant: Apple Inc., Cupertino, CA (US)

(72) Inventors: Alexander Sirotkin, Hod Hasharo (IL); Ping-Heng Kuo, London (GB); Ralf Rossbach, Munich (DE); Naveen Kumar R Palle Venkata, San Diego, CA (US); Fangli Xu, Beijing (CN); Zhibin Wu, Los Altos, CA (US); Haijing Hu, Los Gatos, CA (US); Sethuraman Gurumoorthy, San Ramon, CA (US); Peng Cheng, Beijing (CN); Yuqin Chen, Beijing (CN)

(21) Appl. No.: 19/142,689

(22) PCT Filed: Feb. 1, 2023
(86) PCT No.: PCT/CN2023/074129

§ 371 Date: Jun. 24, 2025

(51) Int. Cl. H04L 5/00; H04W 64/00; H04W 76/27

(52) U.S. Cl. CPC H04L 5/0044; H04W 64/00; H04W 76/27

(57) ABSTRACT

This disclosure relates to techniques for configuring and performing uplink positioning signaling in radio resource control inactive for multiple cells in a wireless communication system. A wireless device may receive uplink sounding reference signal configuration information that provides uplink sounding reference signal configuration for multiple cells. The wireless device may perform uplink sounding reference signal transmission in each of multiple cells using the uplink sounding reference signal configuration information, for example including before and after performing cell re-selection from one cell to another cell.

### FIELD

The present application relates to wireless communications, and more particularly to systems, apparatuses, and methods for configuring and performing uplink positioning signaling in radio resource control inactive for multiple cells in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1×RTT, 1×EV-DO, HRPD, eHRPD), IEEE 802.11 (WLAN or Wi-Fi), BLUETOOTH™, etc.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for configuring and performing uplink positioning signaling in radio resource control inactive for multiple cells in a wireless communication system.

According to the techniques described herein, a cellular base station may provide positioning uplink sounding reference signal configuration information to a wireless device. The configuration information may configure positioning uplink sounding reference signals for multiple cells, for example by providing a list of multiple cells for which a given configuration is valid and/or by providing multiple configurations, each being valid for one or more cells.

The wireless device may be able to use the configuration information to perform cell re-selection among the cells for which a positioning uplink sounding reference signal configuration is available and transmit positioning uplink sounding reference signal in accordance with the configuration information without receiving further signaling to configure the positioning uplink sounding reference signals, which may reduce the overall need for signaling and correspondingly reduce wireless device power consumption.

To further support such possible operation, techniques are also described for notifying a cellular network when a wireless device does not have a positioning uplink sounding reference signal configuration for its current cell, for example to handle a scenario in which the wireless device performs cell re-selection to a cell for which the positioning uplink sounding reference signal configuration information previously received by the wireless device does not include positioning uplink sounding reference signal configuration.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 is a flowchart diagram illustrating aspects of an exemplary possible method for configuring and performing uplink positioning signaling in radio resource control inactive for multiple cells in a wireless communication system, according to some embodiments;

FIGS. 6-7 illustrate exemplary aspects of possible information elements that could be used to indicate when a wireless device does not have a valid configuration for uplink sounding reference signal for positioning for its current cell using NRPPa and Xn communication interfaces, according to some embodiments; and

FIGS. 8-9 illustrate exemplary aspects of possible LPP signaling messages that could be used to indicate when a wireless device does not have a valid configuration for uplink sounding reference signal for positioning for its current cell, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
GSM: Global System for Mobile Communication
UMTS: Universal Mobile Telecommunication System
LTE: Long Term Evolution
NR: New Radio
TX: Transmission/Transmit
RX: Reception/Receive
RAT: Radio Access Technology

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well as any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

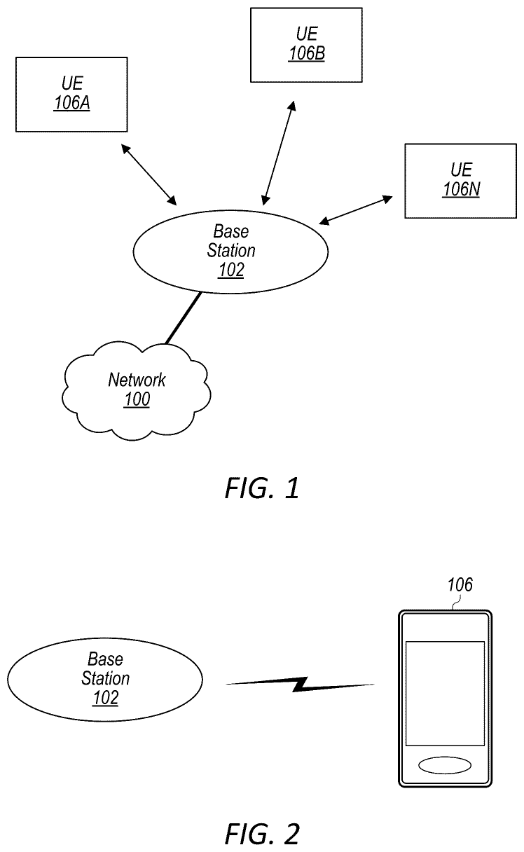

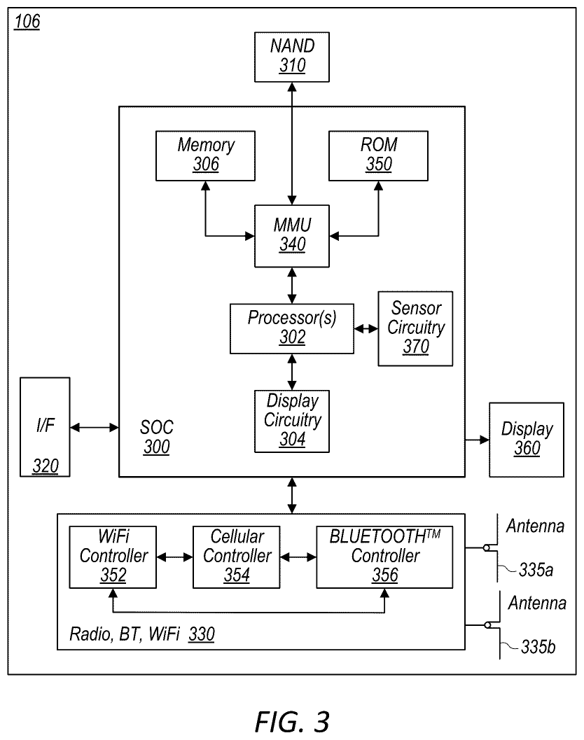

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

Note that, at least in some 3GPP NR contexts, base station (gNB) functionality can be split between a centralized unit (CU) and a distributed unit (DU). The illustrated base station 102 may support the functionality of either or both of a CU or a DU, in such a network deployment context, at least according to some embodiments. In some instances, the base station 102 may be configured to act as an integrated access and backhaul (IAB) donor (e.g., including IAB donor CU and/or IAB donor DU functionality). In some instances, the base station 102 may be configured to act as an IAB node (e.g., including IAB mobile termination (MT) and IAB-DU functionality). Other implementations are also possible.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform uplink positioning signaling in radio resource control inactive for multiple cells in a wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM), and separate radios for communicating using each of Wi-Fi and BLUETOOTH™. Other configurations are also possible.

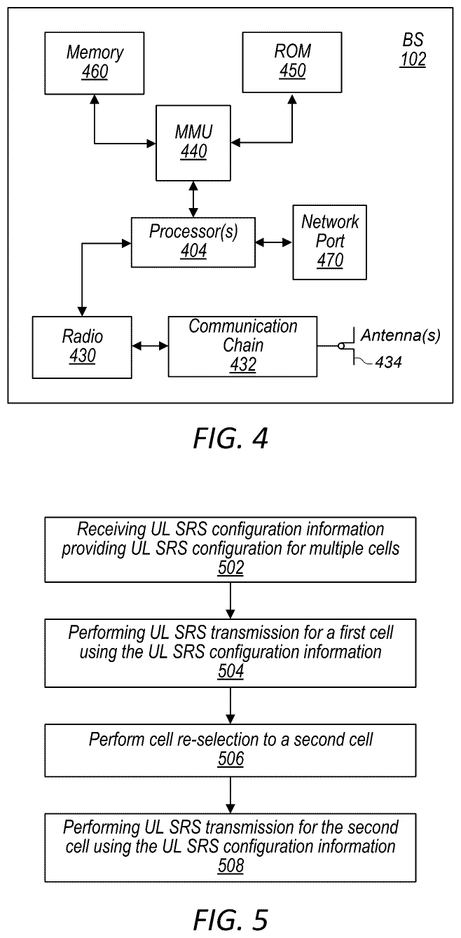

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. The communication circuitry may include multiple receive chains and/or multiple transmit chains for receiving and/or transmitting multiple spatial streams, such as in a multiple-input multiple output (MIMO) configuration. As noted above, the UE may be configured to communicate wirelessly using multiple wireless communication standards in some embodiments.

The UE 106 may include hardware and software components for implementing methods for the UE 106 to perform uplink positioning signaling in radio resource control inactive for multiple cells in a wireless communication system, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform uplink positioning signaling in radio resource control inactive for multiple cells in a wireless communication system according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

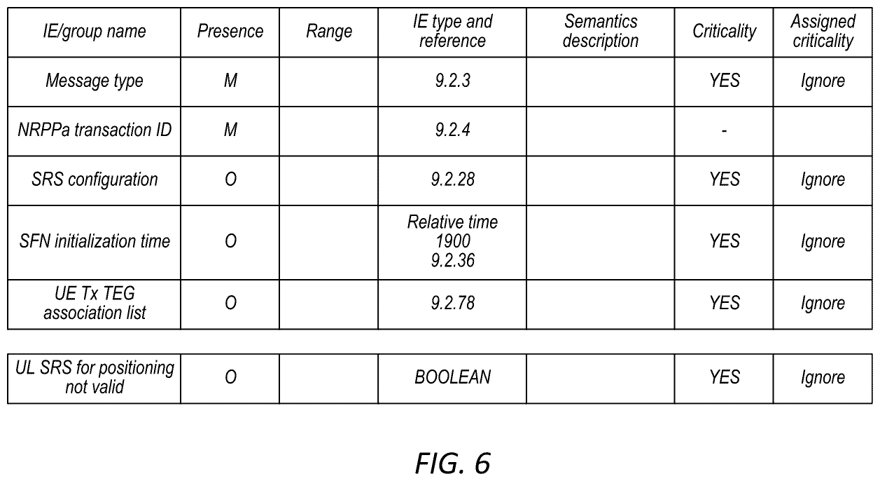

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

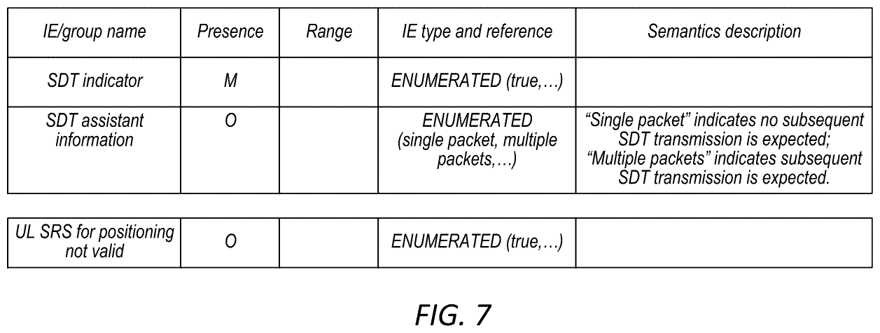

FIG. 5—Configuring and Performing Uplink Positioning Signaling in Radio Resource control Inactive for Multiple Cells

Positioning signaling can be used for a variety of beneficial purposes for wireless devices, potentially including navigation, safety, logistics, augmented and virtual reality, and/or numerous other possible uses. In a 3GPP context, positioning signaling could include positioning reference signal (PRS) in the downlink direction, and/or sounding reference signal (SRS) for positioning in the uplink direction, among various possibilities. Such signaling can be useful in multiple operating modes, for example potentially including both radio resource control (RRC) connected and RRC inactive operating modes. Achieving an effective positioning signaling framework with a relatively low network signaling and power consumption impact may accordingly be a valuable outcome, at least according to some embodiments.

One possible aspect of providing such a framework could include supporting the possibility that positioning signaling configuration can be provided for multiple cells. Such a possibility could have the potential to reduce the amount of signaling performed and/or reduce wireless device power consumption, which in particular may improve battery life for battery-powered devices. Such techniques may, for example, benefit wireless devices that receive uplink positioning signaling configuration for operation in radio resource control inactive mode, e.g., in comparison to an existing approach to providing uplink positioning signaling configuration that is valid for only a single cell in such a scenario.

Thus, it may be beneficial to provide techniques for configuring and performing uplink positioning signaling in radio resource control (RRC) inactive for multiple cells. To illustrate one such set of possible techniques, FIG. 5 is a flowchart diagram illustrating a method for configuring and performing uplink positioning signaling in radio resource control inactive for multiple cells, at least according to some embodiments.

Aspects of the method of FIG. 5 may be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 5 are described in a manner relating to the use of communication techniques and/or features associated with 3GPP and/or NR specification documents, such description is not intended to be limiting to the disclosure, and aspects of the method of FIG. 5 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 5 may operate as follows.

The wireless device may establish a wireless link with a cellular base station. According to some embodiments, the wireless link may include a cellular link according to 5G NR. For example, the wireless device may establish a session with an AMF entity of the cellular network by way of one or more gNBs that provide radio access to the cellular network. As another possibility, the wireless link may include a cellular link according to LTE. For example, the wireless device may establish a session with a mobility management entity of the cellular network by way of an eNB that provides radio access to the cellular network. Other types of cellular links are also possible, and the cellular network may also or alternatively operate according to another cellular communication technology (e.g., UMTS, CDMA2000, GSM, etc.), according to various embodiments.

Establishing the wireless link may include establishing a RRC connection with a serving cellular base station, at least according to some embodiments. Establishing the first RRC connection may include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a certain period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons.

At least according to some embodiments, the wireless device may establish multiple wireless links, e.g., with multiple TRPs of the cellular network, according to a multi-TRP configuration. In such a scenario, the wireless device may be configured (e.g., via RRC signaling) with one or more transmission control indicators (TCIs), e.g., which may correspond to various beams that can be used to communicate with the TRPs. Further, it may be the case that one or more configured TCI states may be activated by media access control (MAC) control element (CE) for the wireless device at a particular time.

At least in some instances, establishing the wireless link(s) may include the wireless device providing capability information for the wireless device. Such capability information may include information relating to any of a variety of types of wireless device capabilities.

In 502, the wireless device may receive uplink (UL) sounding reference signal (SRS) configuration information. The UL SRS configuration information may be received from a cellular base station that provides a serving cell to the wireless device, at least according to some embodiments. The UL SRS configuration information may provide UL SRS configuration for multiple cells. The UL SRS configuration information may be for periodic or semi-persistent positioning UL SRS transmission in RRC inactive mode, according to some embodiments. For example, the UL SRS configuration information may be provided by a serving/source cell when the cell releases the wireless device from RRC connected mode to RRC inactive mode, e.g., in a “suspend configuration” message.

Provision of UL SRS configuration for multiple cells may be achieved in any of multiple possible ways. As one possibility, the UL SRS configuration information may provide at least one UL SRS configuration that is associated with multiple cells. As another possibility, the UL SRS configuration information may provide multiple UL SRS configurations. Each such UL SRS configuration could be associated with one cell, in some embodiments. Alternatively, each such UL SRS configuration could be associated with one or multiple cells. The cell(s) associated with each UL SRS configuration included in the UL SRS configuration information could be indicated using cell identifier (cell id) information (e.g., a list of cell ids), and/or by indicating one or more radio access network notification areas (RNAs), tracking area identifiers (TAIs), tracking area codes (TACs), or any other identifiers of one or multiple cells.

In 504, the wireless device may perform UL SRS transmission for a first cell using the UL SRS configuration information. The first cell may be a cell that released the wireless device from RRC connected to RRC inactive, or possibly another cell to which the wireless device has performed cell re-selection while operating in RRC inactive mode. The UL SRS configuration information may include an UL SRS configuration for the first cell, and the wireless device may use that UL SRS configuration to perform the UL SRS transmission for the first cell. This may include transmitting UL SRS at one or more times and/or with one or more parameters configured by the UL SRS configuration for the first cell, at least according to some embodiments.

In 506, the wireless device may perform cell re-selection to a second cell. The UL SRS configuration information may also include an UL SRS configuration for the second cell. The UL SRS configuration for the second cell may be the same as the UL SRS configuration for the first cell, or may be a different UL SRS configuration than the UL SRS configuration for the first cell, that was also provided in the UL SRS configuration information received by the wireless device, according to various embodiments.

In 508, the wireless device may perform UL SRS transmission for the second cell using the UL SRS configuration information. This may include transmitting UL SRS at one or more times and/or with one or more parameters configured by the UL SRS configuration for the second cell, at least according to some embodiments.

The wireless device may at some point determine that it does not have a valid UL SRS configuration for its current cell. This may occur, for example, as a result of cell re-selection to a third cell, for which the UL SRS configuration information does not provide UL SRS configuration.

In some embodiments, it may also or alternatively be possible that the UL SRS configuration information validity for the wireless device is time limited (e.g., a timer may be associated with the UL SRS configuration information, and at expiry of the timer the UL SRS configuration information may be considered stale and invalid), in which case the wireless device may determine that it does not have a valid UL SRS configuration for its current cell based on expiration of the UL SRS configuration information. As a still further possibility, the wireless device could receive an explicit indication that the UL SRS configuration (or a portion thereof) is no longer valid for the wireless device.

Based on determining that it does not have a valid UL SRS configuration for its current cell, the wireless device may provide an indication of this to the network. In some embodiments, this may include providing a such an indication to the cellular base station that provides its current cell via MAC CE signaling, random access channel (RACH) signaling (e.g., using a random access profile dedicated for providing such an indication), or RRC signaling. Such signaling may be performed using small data transfer (SDT) communication while in RRC inactive, and/or may be performed using RRC connected communication (e.g., after resuming an RRC connection), according to various embodiments. The cellular base station that receives the indication may in turn provide an indication that the wireless device does not have a UL SRS configuration for its current cell to a location management function (LMF) of the cellular network, for example using NR positioning protocol A (NRPPa) signaling, e.g., if the cellular base station has a NRPPa session for the wireless device. Alternatively, e.g., if the cellular base station does not have a NRPPa session for the wireless device, the cellular base station may provide an indication that the wireless device does not have a UL SRS configuration for its current cell to a cellular base station that provides a source cell for the wireless device, for example using the Xn communication interface. That cellular base station may in turn provide an indication that the wireless device does not have a UL SRS configuration for its current cell to the LMF via a NRPPa session for the wireless device, at least in some embodiments.

As another possibility, it may be the case that the wireless device can provide an indication that it does not have a UL SRS configuration for its current cell using LTE positioning protocol (LPP) signaling. In such a scenario, the cellular base station serving the wireless device may receive the LPP signaling (e.g., the message containing the LPP signaling) and provide it in turn to the LMF.

Note that in some embodiments, it may be the case that provision of an indication that a wireless device does not have a valid UL SRS configuration may be performed immediately upon determining that the wireless device does not have a valid UL SRS configuration, while in other embodiments, it may be the case that a certain amount of time is allowed to elapse after such a determination before such an indication is sent. For example, a timer may be initiated upon determining that wireless device does not have a valid UL SRS configuration for its current cell. The timer may be stopped if the wireless device does have a valid UL SRS configuration for its current cell again before expiry, for example such as might occur if the wireless device perform cell re-selection to another cell for which the UL SRS configuration information does provide UL SRS configuration. If the timer does run until expiry, however, transmission of an indication that the wireless device does not have a valid UL SRS configuration for its current cell may be triggered and performed.

It should also be noted that it may be possible for a wireless device to consider whether it has UL SRS configuration for a cell when performing cell re-selection. For example, the wireless device may be configured (e.g., by network configuration, wireless device design/programming, and/or wireless communication standard specifications) to prefer to select a cell for which UL SRS configuration is available among a set of suitable cells. Such a consideration may be used in conjunction with any number of other cell re-selection considerations, according to various embodiments, if desired.

Once the network has been notified that the wireless device is lacking a valid UL SRS configuration for its current cell, it may be the case that the network provides updated UL SRS configuration information to the wireless device. For example, the wireless device may receive such new UL SRS configuration information, which may similarly potentially apply for multiple cells in a configured validity area, via the cell to which it is currently attached.

Thus, at least according to some embodiments, the method of FIG. 5 may be used to provide a framework according to which a wireless device can be configured to perform UL SRS transmissions for positioning while in RRC inactive state in any of a set of multiple cells for which the wireless device is provided with UL SRS configuration information. This may reduce the need for signaling between the wireless device and the cellular network while in RRC inactive, thus potentially reducing power consumption and network signaling overhead, among various possible benefits, at least in some instances.

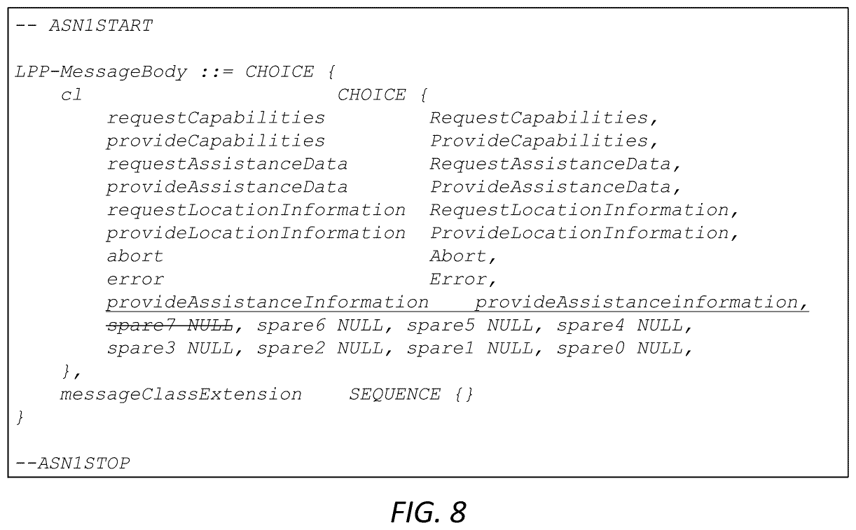

### FIGS. 6-9 and Additional Information

FIGS. 6-9 illustrate further aspects that might be used in conjunction with the method of FIG. 5 if desired. It should be noted, however, that the exemplary details illustrated in and described with respect to FIGS. 6-9 are not intended to be limiting to the disclosure as a whole: numerous variations and alternatives to the details provided herein below are possible and should be considered within the scope of the disclosure.

In 3GPP Release 17, extended positioning assistance data framework is described, including the concept of a “validity area.” For example, if assistance data (e.g., positioning reference signal (PRS) configuration, as one possibility) is accompanied by validity area information (e.g., a cell identifier list indicating cells that make up the validity area), a UE may be able to assume that the assistance information is valid in more than one cell. For example, for such a scenario with configured PRS, a UE may assume that the configured PRS can be received in more than one cell. This general approach may help reduce signaling and improve UE battery life, as for example new PRS configuration information may not need to be configured when a UE moves to a new cell within the validity area of the existing PRS configuration information.

Positioning uplink (UL) sounding reference signal (SRS) transmission in RRC inactive, including both periodic and semi-persistent configurations, could be configured (e.g., using SRS-PosRRC-InactiveConfig-r17 sent to the UE) to be only in the same cell, for example as supported in 3GPP Release 17, at least according to some embodiments. However, when the UE re-selects to a new cell, in such a scenario, it may be necessary to communicate with the network to obtain a new SRS configuration. Accordingly, it may be beneficial to support configuration of positioning UL SRS in multiple cells. In other words, the concept of validity area can also be supported for UL SRS for positioning, at least according to some embodiments, for example potentially in 3GPP Release 18, among various possibilities.

Techniques for performing signaling (e.g., RRC, LTE positioning protocol (LPP), media access control (MAC), NR positioning protocol A (NRPPa)) to support such UL SRS in multiple cells are described herein. It may also be useful to provide techniques for coordination between network nodes to agree on an SRS configuration which is valid in multiple cells, and ensure that uplink time alignment is valid across multiple cells, to support UL SRS configuration for multiple cells. Such coordination can be achieved via NRPPa, with location management function (LMF) collecting SRS information from multiple gNBs/TRPs, finding the most suitable configuration to be applicable in multiple cells, and communicating that configuration back to the gNBs/TRPs and the UE, as one possibility. As another possibility, “horizontal” signaling exchange between the gNBs via the Xn communication interface may be used to coordinate on an UL SRS configuration that is valid for multiple cells for a UE. Other coordination techniques, and/or variations on such techniques, are also possible.

One aspect of supporting UL SRS configuration in multiple cells may include the signaling of single and/or multiple UL SRS configurations with validity area information. In some instances, a “SuspendConfig” message provided when releasing a UE from RRC connected to RRC inactive may carry a SRS-PosRRC-InactiveConfig-r17 information element (IE). While it may be possible for this IE to contain a single UL SRS configuration for a single cell, as a possible enhancement, it may also be possible for validity area information that could potentially indicate applicability to multiple cells to be associated with a UL SRS configuration. As another possibility, it may be possible for the SuspendConfig message to carry a list of UL SRS configurations, with each being valid for a specific cell. As a still further possibility, it may be possible for the SuspendConfig message to carry a list of UL SRS configurations, where each entry in the list contains SRS-PosRRC-InactiveConfigg-r17 and validity area IE, e.g., such that each UL SRS configuration could be associated with one or multiple cells. In scenarios in which a validity area IE is used, the validity area IE can be defined as a list of cell identifiers, a list of radio access network notification areas (RNAs), tracking area identifiers (TAIs), and/or tracking area codes (TACs), among various possibilities.

The provided UL SRS configuration(s) may be considered valid as long as the UE is camped on one of the cells in the validity area(s) associated with the UL SRS configuration(s), as one possibility. In some instances, a timer-based condition could also or alternatively be applied to the provided UL SRS configuration(s); for example, a validity timer could be initiated based on receiving UL SRS configuration information, and the UL SRS configuration information could be considered invalid (expired) upon expiry of the validity timer. One or more conditions for resetting such a validity timer (e.g., to extend the validity of configuration information that is actively being used) could be configured or specified, if desired. Another possible condition for invalidating UL SRS configuration information could include a UE receiving explicit indication from the network that one or more UL SRS configurations are invalid and/or indication of newer UL SRS configuration information.

In some instances, the network may signal to the UE whether it is allowed to keep the uplink time alignment timer (e.g., inactivePosSRS-TimeAlignmentTimer) running when re-selecting to a new cell (e.g., in the validity area). Alternatively, the network may signal to the UE if it needs to restart inactivePosSRS-TimeAlignmentTimer when re-selecting to a new cell. In some instances, it may be possible for a single (e.g., more flexible) UL SRS configuration to be used together with the validity area indication and the uplink time alignment indication.

Another aspect of supporting UL SRS configuration in multiple cells may include providing techniques and procedures for handling when a UE leaves the validity area associated with the UL SRS configuration provided to the UE (e.g., moves to a cell not included in the validity area), or the UL SRS configuration otherwise becomes invalid. If the UE still needs or desires to perform positioning signaling, in such a scenario, the UE may need to notify the network in order to facilitate receiving a new UL SRS for positioning configuration, and/or for the network to be able to stop monitoring for UL SRS in the cells in which the UE is no longer expected to be. As one possibility, the UE may be able to perform a RRC resume operation and request new UL SRS configuration information, in such a scenario. Alternatively, or additionally, it may be possible to support one or more other types of signaling to provide such a notification, possibly including making use of small data transfer (SDT) techniques to perform such signaling without resuming RRC connected mode. For example, one or more of MAC CE (+NRPPa), RRC (e.g., UEAssistanceInformation) (+NRPPa), and/or LPP signaling could be used, via SDT and/or after transitioning to RRC connected, could be used to indicate that the positioning UL SRS configuration for a UE is invalid.

Note that in some instances, it may be possible that a timer can be used to potentially avoid the need to perform such signaling in case of a UE exiting the validity area for its UL SRS configuration for only a short period of time. For example, a UE may start such a timer when it goes outside of the validity area, and if, after a certain amount of time (e.g., pre-defined or configured by the network), the UE is still outside of the validity area, the UE may then indicate to the network that its UL SRS configuration is invalid (and potentially that it needs a new UL SRS configuration).

For MAC CE signaling, a MAC CE for “UE is outside of UL SRS validity area” (or possibly “invalid UL SRS configuration for UE,” among other possibilities) can be defined. It may be the case that no additional information is carried by the MAC CE and that it can be 0 bits length; a new extended logical channel ID (eLCID) defined for the MAC CE may be sufficient to identify the MAC CE. If desired, the MAC CE could indicate one or more SRS identifiers, for example to indicate that one or more specific SRS configurations are no longer valid. Note that if the UE supports SDT, it may be possible that SDT can be used to transfer this indication.

Another possibility could include dedicating a random access preamble for use for indication of an invalid UL SRS configuration for a UE, which can be used to perform a random access channel (RACH) procedure by the UE.

Still another possibility could include using RRC UEAssistanceInformation to indicate an invalid UL SRS configuration for a UE. Similar to a MAC CE based approach, such assistance information may just be an indication that a UE is outside of the UL SRS validity area that carries no additional information, as one possibility. As another possibility, such an indication may carry one or more SRS identifiers, e.g., to indicate which SRS configuration(s) is (are) not valid. Note that if the UE supports SDT, it may be possible that SDT can be used to transfer this indication. As an example, such RRC signaling could be defined as follows, according to one set of embodiments:

```
UEAssistanceInfomration-v1800-IEs ::= SEQUENCE {
          ul-PosSRSInvalid BOOLEAN OPTIONAL,
          nonCriticalExtension SEQUENCE { } OPTIONAL
}
```

Whether MAC CE, RACH, or RRC UEAssistanceInformation is used to indicate to a gNB that a UE does not have a valid UL SRS configuration for its current cell, it may be the case that the gNB needs to relay this information to the LMF. At least according to some embodiments, it may be possible to enhance NRPPa POSITIONING INFORMATION UPDATE to carry this information. FIG. 6 is a table defining a possible POSITIONING INFORMATION UPDATE message that could include a field for indicating that UL SRS for positioning is not valid for a UE. As shown, this could be a Boolean IE indicating that a UE is no longer in the UL SRS validity area, at least as one possibility.

In some scenarios, it could be the case that the gNB receiving the UE's indication that it does not have a valid UL SRS configuration for its current cell has not established a NRPPa session for that UE. To handle such scenarios, it may also be useful to support relaying such an indication to the source gNB for the UE, for example using (enhanced) “SDT Support Request” IE in the RETRIEVE UE CONTEXT REQUEST” Xn-AP message. FIG. 7 is a table defining such a possible SDT Support Request IE that could include a field for indicating that UL SRS for positioning is not valid for a UE.

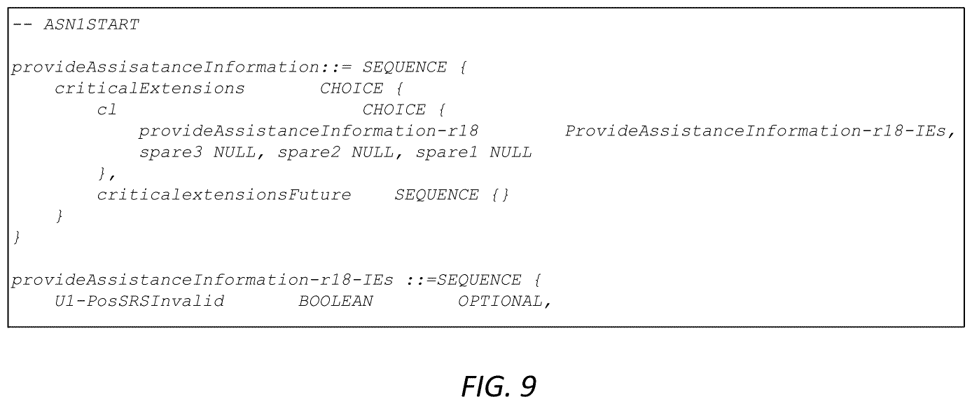

Use of LPP signaling may represent an alternative possible approach to use of MAC CE, RACH, or RRC UEAssistanceInformation plus NRPPa signaling to inform the network that UL SRS for positioning is not valid for a UE. In some embodiments, for example, it may be possible to define a new ProvideAssistanceInformation LPP message for this purpose. FIG. 8 illustrates how an LPP MessageBody message could be re-defined to allow for indication of such an LPP message type, e.g., in which the “spare7” choice has been updated to instead reflect indication of a “provideAssistanceInformation” LPP message type choice, at least according to some embodiments. FIG. 9, in turn, illustrates how such a ProvideAssistanceInformation LPP message body in a LPP message could indicate the assistance information of a target device to the location server, at least according to some embodiments.

Note that in some instances, it may be possible that whether a cell is included in the validity area for the positioning UL SRS configuration for a UE can be considered as a factor in cell re-selection. For example, the UE may prefer a cell (among all suitable cells) that is included in the validity area for the positioning UL SRS configuration for the UE. Such a preference may be one consideration among any number of other possible considerations, according to various embodiments. This can be configured by the network (e.g., in SuspendConfig), left for UE implementation to determine, or set forth in 3GPP specifications, as various possibilities.

In the following further exemplary embodiments are provided.

One set of embodiments may include a method, comprising: by a wireless device: receiving uplink (UL) sounding reference signal (SRS) configuration information, wherein the UL SRS configuration information provides UL SRS configuration for multiple cells, wherein the multiple cells include at least a first cell and a second cell; performing UL SRS transmission for the first cell using the UL SRS configuration information; performing cell re-selection to the second cell; and performing UL SRS transmission for the second cell using the UL SRS configuration information.

According to some embodiments, the UL SRS configuration information is for positioning UL SRS transmission in a radio resource control (RRC) inactive mode.

According to some embodiments, the UL SRS configuration information provides multiple UL SRS configurations, wherein each UL SRS configuration provided in the UL SRS configuration information is associated with one or more cells.

According to some embodiments, the UL SRS configuration information provides an UL SRS configuration that is associated with multiple cells.

According to some embodiments, the multiple cells associated with the UL SRS configuration are indicated in the UL SRS configuration information using one or more of: a list of cell ids; a list of radio access network notification areas; a list of tracking area identifiers; or a list of tracking area codes.

According to some embodiments, the method further comprises: performing cell re-selection to a third cell, wherein the UL SRS configuration information does not provide UL SRS configuration for the third cell; and providing an indication to the third cell that the wireless device does not have an UL SRS configuration for the third cell.

According to some embodiments, the indication that the wireless device does not have an UL SRS configuration for the third cell is provided to the third cell using one of: media access control (MAC) control element (CE) signaling; random access channel (RACH) signaling; radio resource control (RRC) signaling; or LTE positioning protocol (LPP) signaling.

According to some embodiments, the indication that the wireless device does not have an UL SRS configuration for the third cell is provided to the third cell using one of: small data transfer (SDT) communication while radio resource control (RRC) inactive; or RRC connected communication.

According to some embodiments, the method further comprises: initiating a timer based at least in part on the UL SRS configuration information not providing UL SRS configuration for the third cell, wherein the indication to the third cell that the wireless device does not have an UL SRS configuration for the third cell is provided based at least in part on expiration of the timer.

According to some embodiments, performing cell re-selection to the second cell is based at least in part on a configured preference to select a cell for which the UL SRS configuration information provides an UL SRS configuration.

Another set of embodiments may include a wireless device, comprising: one or more processors; and a memory having instructions stored thereon, which when executed by the one or more processors, perform steps of the method of any of the preceding examples.

Yet another set of embodiments may include a method, comprising: by a first cellular base station configured to provide a first cell in a cellular network: providing positioning uplink (UL) sounding reference signal (SRS) configuration information to a first wireless device, wherein the positioning UL SRS configuration information provides positioning UL SRS configuration for multiple cells.

According to some embodiments, the positioning UL SRS configuration information provides multiple positioning UL SRS configurations, wherein each positioning UL SRS configuration provided in the positioning UL SRS configuration information is associated with one or more cells.

According to some embodiments, the positioning UL SRS configuration information provides a positioning UL SRS configuration that is associated with multiple cells, wherein the multiple cells associated with the positioning UL SRS configuration are indicated in the positioning UL SRS configuration information using one or more of: a list of cell identifiers; a list of radio access network notification areas; a list of tracking area identifiers; or a list of tracking area codes.

According to some embodiments, the method further comprises: receiving an indication that a second wireless device does not have a positioning UL SRS configuration for its current cell, wherein the indication that the second wireless device does not have a positioning UL SRS configuration for its current cell is received using one of: media access control (MAC) control element (CE) signaling; random access channel (RACH) signaling; or radio resource control (RRC) signaling.

According to some embodiments, the method further comprises: determining that the first cell does not have an established NR positioning protocol A (NRPPa) session for the second wireless device; and providing an indication that the second wireless device does not have a positioning UL SRS configuration for its current cell to a second cellular base station based at least in part on determining that the first cell does not have an established NRPPa session for the second wireless device, wherein the second cellular base station provides a source cell for the second wireless device.

According to some embodiments, the method further comprises: determining that the first cell has an established NR positioning protocol A (NRPPa) session for the second wireless device; and providing an indication that the second wireless device does not have a positioning UL SRS configuration for its current cell to a location management function (LMF) of the cellular network using NRPPa signaling based at least in part on determining that the first cell has an established NRPPa session for the second wireless device.

According to some embodiments, the method further comprises: receiving a message containing LTE positioning protocol (LPP) signaling indicating that second wireless device does not have a positioning UL SRS configuration for the first cell; and providing the message containing the LPP signaling to a location management function (LMF) of the cellular network.

Still another set of embodiments may include a cellular base station, comprising: one or more processors; and a memory having instructions stored thereon, which when executed by the one or more processors, perform steps of the method of any of the preceding examples.

A still further set of embodiments may include a computer program product, comprising computer instructions which, when executed by one or more processors, perform steps of the method of any of the preceding examples.

A further exemplary embodiment may include a method, comprising: performing, by a wireless device, any or all parts of the preceding examples.

Another exemplary embodiment may include a device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
receiving uplink (UL) sounding reference signal (SRS) configuration information, wherein the UL SRS configuration information provides UL SRS configuration for multiple cells, wherein the multiple cells include at least a first cell and a second cell;
performing UL SRS transmission for the first cell using the UL SRS configuration information;
performing cell re-selection to the second cell; and
performing UL SRS transmission for the second cell using the UL SRS configuration information.

2. The method of claim 1,
wherein the UL SRS configuration information is for positioning UL SRS transmission in a radio resource control (RRC) inactive mode.

3. The method of claim 1,
wherein the UL SRS configuration information provides multiple UL SRS configurations, wherein each UL SRS configuration provided in the UL SRS configuration information is associated with one or more cells.

4. The method of claim 1,
wherein the UL SRS configuration information provides an UL SRS configuration that is associated with multiple cells.

5. The method of claim 4,
wherein the multiple cells associated with the UL SRS configuration are indicated in the UL SRS configuration information using one or more of:
a list of cell ids;
a list of radio access network notification areas;
a list of tracking area identifiers; or
a list of tracking area codes.

6. The method of claim 1, wherein the method further comprises:
performing cell re-selection to a third cell, wherein the UL SRS configuration information does not provide UL SRS configuration for the third cell; and
providing an indication to the third cell that a wireless device does not have an UL SRS configuration for the third cell.

7. The method of claim 6,
wherein the indication that the wireless device does not have an UL SRS configuration for the third cell is provided to the third cell using one of:
media access control (MAC) control element (CE) signaling;
random access channel (RACH) signaling;
radio resource control (RRC) signaling; or
LTE positioning protocol (LPP) signaling.

8. The method of claim 6,
wherein the indication that the wireless device does not have an UL SRS configuration for the third cell is provided to the third cell using one of:
small data transfer (SDT) communication while radio resource control (RRC) inactive; or
RRC connected communication.

9. The method of claim 6, wherein the method further comprises:
initiating a timer based at least in part on the UL SRS configuration information not providing UL SRS configuration for the third cell,
wherein the indication to the third cell that the wireless device does not have an UL SRS configuration for the third cell is provided based at least in part on expiration of the timer.

10. The method of claim 1,
wherein performing cell re-selection to the second cell is based at least in part on a configured preference to select a cell for which the UL SRS configuration information provides an UL SRS configuration.

11. (canceled)

12. A method, comprising:
by a first cellular base station configured to provide a first cell in a cellular network:
providing positioning uplink (UL) sounding reference signal (SRS) configuration information to a first wireless device, wherein the positioning UL SRS configuration information provides positioning UL SRS configuration for multiple cells.

13. The method of claim 12,
wherein the positioning UL SRS configuration information provides multiple positioning UL SRS configurations, wherein each positioning UL SRS configuration provided in the positioning UL SRS configuration information is associated with one or more cells.

14. The method of claim 12,
wherein the positioning UL SRS configuration information provides a positioning UL SRS configuration that is associated with multiple cells, wherein the multiple cells associated with the positioning UL SRS configuration are indicated in the positioning UL SRS configuration information using one or more of:
a list of cell identifiers;
a list of radio access network notification areas;
a list of tracking area identifiers; or
a list of tracking area codes.

15. The method of claim 12, wherein the method further comprises:
receiving an indication that a second wireless device does not have a positioning UL SRS configuration for its current cell, wherein the indication that the second wireless device does not have a positioning UL SRS configuration for its current cell is received using one of:
media access control (MAC) control element (CE) signaling;
random access channel (RACH) signaling; or
radio resource control (RRC) signaling.

16. The method of claim 15, wherein the method further comprises:
determining that the first cell does not have an established NR positioning protocol A (NRPPa) session for the second wireless device; and
providing an indication that the second wireless device does not have a positioning UL SRS configuration for its current cell to a second cellular base station based at least in part on determining that the first cell does not have an established NRPPa session for the second wireless device, wherein the second cellular base station provides a source cell for the second wireless device.

17. The method of claim 15, wherein the method further comprises:
determining that the first cell has an established NR positioning protocol A (NRPPa) session for the second wireless device; and
providing an indication that the second wireless device does not have a positioning UL SRS configuration for its current cell to a location management function (LMF) of the cellular network using NRPPa signaling based at least in part on determining that the first cell has an established NRPPa session for the second wireless device.

18. The method of claim 12, wherein the method further comprises:
receiving a message containing LTE positioning protocol (LPP) signaling indicating that second wireless device does not have a positioning UL SRS configuration for the first cell; and
providing the message containing the LPP signaling to a location management function (LMF) of the cellular network.

19-20. (canceled)

21. An apparatus, comprising:
a processor configured to, when executing instructions stored in a memory, perform operations comprising:
receiving uplink (UL) sounding reference signal (SRS) configuration information, wherein the UL SRS configuration information provides UL SRS configuration for multiple cells, wherein the multiple cells include at least a first cell and a second cell;
performing UL SRS transmission for the first cell using the UL SRS configuration information;
performing cell re-selection to the second cell; and
performing UL SRS transmission for the second cell using the UL SRS configuration information.

22. The apparatus of claim 21,
wherein the UL SRS configuration information is for positioning UL SRS transmission in a radio resource control (RRC) inactive mode.

23. The apparatus of claim 21,
wherein the UL SRS configuration information provides multiple UL SRS configurations, wherein each UL SRS configuration provided in the UL SRS configuration information is associated with one or more cells.
